(19) United States
(12) Patent Application Publication
(10) Pub. No.: US 2003/0030869 A1
(43) Pub. Date: Feb. 13, 2003

(54) Active real-time alignment system for optoelectronic (OE) devices

(75) Inventors: Eric V. Kline, Clinton Corners, NY (US); Subhash L. Shinde, Cortlandt Manor, NY (US)

Correspondence Address: Sean F. Sullivan, Esq., Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 09/924,317

(22) Filed: Aug. 8, 2001

(51) Int. Cl. H04B 10/00

(52) U.S. Cl. 359/159; 359/154

(57) ABSTRACT

A real-time, optoelectronic (OE) alignment system, including a first OE device and a second OE device optically coupled to the first OE device, is disclosed. In an exemplary embodiment of the invention, the alignment system includes a capturing means for maintaining the second OE device in a fixed position. The capturing means further retains the first OE device in optical engagement with the second OE device, with the first OE device further having a plurality of degrees of positional freedom associated therewith. An error detection means generates a positional error signal whenever either of the first and second OE devices has deviated from a desired optical alignment with respect to the other. In addition, an actuation means, responsive to the error detection means, automatically adjusts the position of the first OE device so as to bring said first OE device in the desired optical alignment with said second OE device.

### BACKGROUND

The present invention relates generally to optical communication devices and, more particularly, to an active real-time alignment system for optoelectronic (OE) devices.

Optical communication systems offer many advantages over other communications systems, such as those implementing copper wire or radio frequency links as a transmission medium. Such advantages include, among other things: lower transmission losses, higher bandwidths, higher transmission rates, lower implementation costs, and greater electrical isolation characteristics. Because of these and other advantages, great efforts are currently being made to develop and implement optical fiber communication systems. Thus, such systems will most likely continue to dominate the telecommunications industry in the forseeable future.

The alignment of optoelectronic (OE) devices, both initially and in the maintenance thereof during sustained operation, is a critical aspect of optical communications in networks. A misalignment of OE devices contributes to the loss of optical power coupled between transmitting and receiving termini which, in turn, may result in high data error rates and/or no data transmission.

In conventional alignment systems for optical devices, OE components are typically configured in accordance with a simple “align and affix” procedure. That is, once the optical transmitting and receiving components are initially aligned with one another during a fabrication process, the components are then “permanently” affixed with respect to one another. In reality, however, once a initial alignment is accomplished, an OE device is often susceptible to effects such as change in Coefficient of Thermal Expansion (CTE) mismatches, due to thermal excursions and/or mechanical creeps resulting from stress relaxation phenomena, etc. As a result, the once satisfactory initial alignment may subsequently be unsatisfactory, with no practical means of realignment, thereby leading to the aforementioned difficulties associated with misalignment.

### BRIEF SUMMARY

The foregoing discussed drawbacks and deficiencies of the prior art are overcome or alleviated by a real-time, optoelectronic (OE) alignment system including a first OE device and a second OE device optically coupled to the first OE device. In an exemplary embodiment of the invention, the alignment system includes a capturing means for maintaining the second OE device in a fixed position. The capturing means further retains the first OE device in optical engagement with the second OE device, with the first OE device further having a plurality of degrees of positional freedom associated therewith. An error detection means generates a positional error signal whenever either of the first and second OE devices has deviated from a desired optical alignment with respect to the other. In addition, an actuation means, responsive to the error detection means, automatically adjusts the position of the first OE device so as to bring said first OE device in the desired optical alignment with said second OE device.

In a preferred embodiment, the second OE device is affixed to a reference plane, the first OE device is movably disposed within a housing which, in turn, is affixed with respect to the second OE device. The actuation means is disposed within the housing. Preferably, the first OE device further comprises one of an active device emitter and an emitting end of a fiber optic cable. The error detection means further includes a beam position structure, affixed to one of the first and second OE devices, the beam position structure located so as to reflect a portion of an incident optical beam originating from the other of said first and second OE devices. An optical sensing device is located so as to detect the reflected portion of the incident optical beam, wherein the optical sensing device generates the positional error signal which has a magnitude proportional to the degree of deviation from the desired optical alignment.

### BRIEF DESCRIPTION OF THE DRAWINGS

Referring to the exemplary drawings wherein like elements are numbered alike in the several Figures:

FIG. 1 is a schematic diagram of an active, real-time alignment system for optoelectronic devices, in accordance with an embodiment of the invention;

FIGS. 2(a) and 2(b) are schematic diagrams which illustrate positional degrees of freedom for a first OE device included within the real-time alignment system;

FIG. 3(a) is a partial schematic diagram of the active, real-time alignment system in FIG. 1, illustrating an embodiment of a position error signal (PES) generation device;

FIG. 3(b) is a schematic diagram illustrating an alternative embodiment for the position error signal generation depicted in FIGS. 1 and 3(a);

FIG. 4 is a schematic diagram of one possible embodiment of an actuator mechanism included within the real-time alignment system;

FIG. 5 is a top-sectional view (in the x-y plane) illustrating a multiple degree of freedom embodiment of an actuator mechanism included within the real-time alignment system;

FIG. 6 is another view of the multiple degree of freedom actuator mechanism (shown in the y-z plane) as viewed from the direction of arrow 6 in FIG. 5;

FIG. 7 is still another view of the multiple degree of freedom actuator mechanism (shown in the x-z plane);

FIG. 8 is a diagram which illustrates a positional error correction in one degree of freedom by the adjustment of an incident optical beam along a focal axis;

FIG. 9 is an alternative embodiment of the active, real-time alignment system, wherein the components thereof are included within a single, self-contained housing.

### DETAILED DESCRIPTION

Disclosed herein is an active, real-time alignment system for optoelectronic (OE) devices which provides improved optical coupling efficiency (i.e., energy transfer) therebetween, regardless of whether the devices operate in a guided wave or a free-space domain. The alignment system takes advantage of an OE device capturing means (having several degrees of positional freedom associated therewith), a positional error signal (PES) generation means, derived from the incident optical data beam, and an actuation means (responsive to the PES generation means) for providing active and real-time alignment of the OE devices along the degrees of positional freedom. Unlike conventional systems, the present invention embodiments provide for real-time compensation for positional drifts of one OE component with respect to another from phenomena such as thermal excursions, mechanical strain relaxations, and the like.

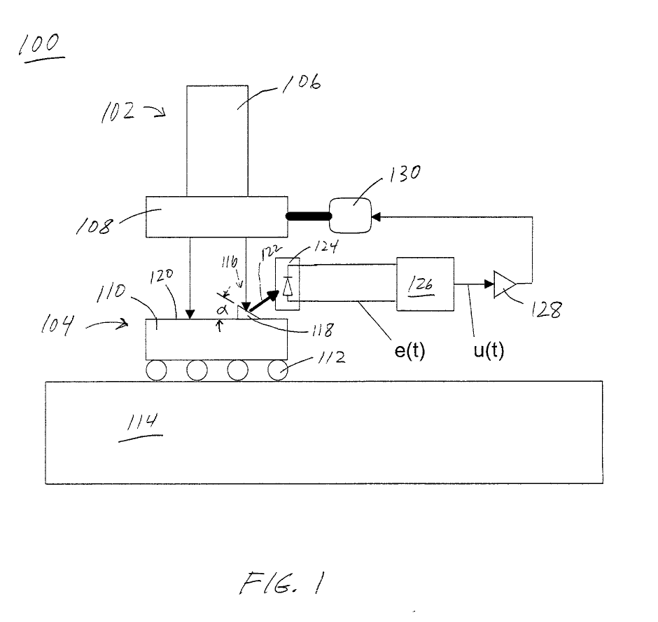

Referring initially to FIG. 1, there is shown a schematic diagram of an active, real-time alignment system 100 for optoelectronic devices, in accordance with an embodiment of the invention. A first OE device 102 is optically coupled to a second OE device 104. The first OE device 102 may include an active device emitter or, alternatively, the emitting end of a passive device such as a fiber optic cable 106 which is movably disposed within a fixed housing or carrier piece 108. The second OE device may include an optical data detector 110. In the embodiment shown, the first OE device 102 is the actuated (i.e., moveable) device, whereas the second OE device 104 is mechanically affixed with respect to a reference plane (not shown), such as by bonding with a ball grid array 112 to a substrate 114. Housing 108 is also fixed directly or indirectly to the same reference plane as is second OE device 104. It will be appreciated, however, that the alignment system 100 may alternatively be configured such that the optical emitting device is the affixed device and the optical detecting device is the actuated or moveable device.

A positional error signal (PES) generation device 116 includes at least one beam position structure 118 positioned upon the incident face 120 of optical data detector 110. For illustration purposes only, there is just a single beam position structure 118 shown in FIG. 1. As will be described in greater detail later, however, alignment system 100 contemplates multiple beam position structures 118 or multiple sets of structures, with each structure or set of structures corresponding to a one-dimensional degree of freedom.

An exemplary embodiment of beam position structure 118 includes a mirror, disposed at an acute angle a with respect to the incident face 120 of data detector 110. The mirror reflects an optical error signal 122 (which is a reflected portion of the incident optical beam) toward an appropriately positioned error detection device 124, such as a PIN diode. The error detection device 124 converts the optical error signal to an electrical error signal e(t), which is then fed to a controller 126. Controller 126 receives error signal e(t) and converts it to a correction signal u(t), which is thereafter amplified and/or suitably conditioned by driver 128. Finally, driver 128 provides a controlled current for an actuator mechanism 130 which, in turn, imparts a mechanical force upon the first OE device 102, thereby producing a corrective alignment. Again, the embodiment in FIG. 1 depicts a one-dimensional (1 degree of freedom) system, whereas a preferred embodiment of alignment system 100 will actually have multiple degrees of freedom associated therewith, as will now be described in further detail.

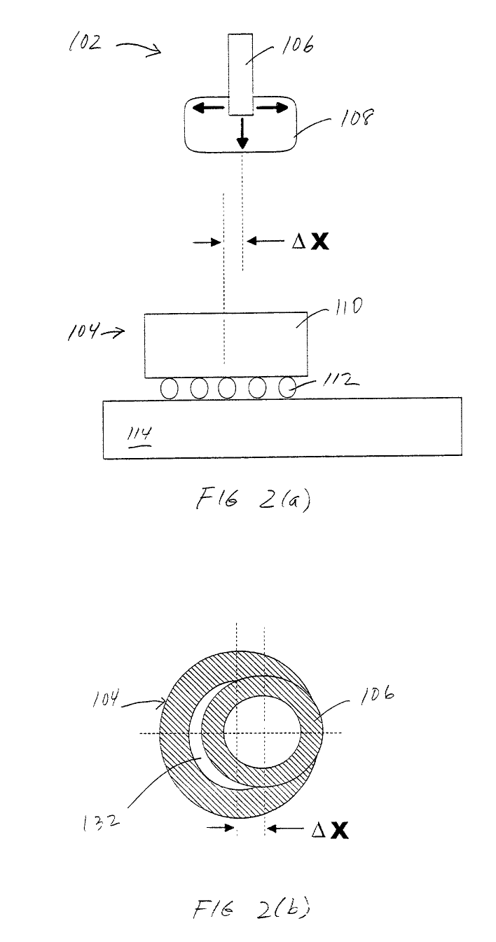

FIGS. 2(a) and 2(b) illustrate the positional degrees of freedom for the first OE device 102. While housing 108 is in a fixed position as relating to the second OE device 104, the emitter end of fiber optic cable 106 is free to move along the x, y, or z (focal) axis to provide the desired alignment of first OE device 102 and second OE device 104. Additional degrees of freedom of first OE device 102 are also possible, such as angular or rotational freedom. Although the range of motion of the translational degress of freedom (i.e., along the x, y, z-axes) is not limited by the present disclosure, for practical purposes it is estimated that the translational motion range is on the order of about 500 μm. FIGS. 2(a) and 2(b) further illustrate, by way of example, a misalignment of the first and second OE devices 102, 104 along the x-axis by a distance Δx. In particular, FIG. 2(b) is a cross-sectional top view, taken along the z-axis or focal axis, illustrating the misalignment in the x-direction of the emitter end of fiber optic cable 106 with respect to the target area 132 of the optical data detector 110.

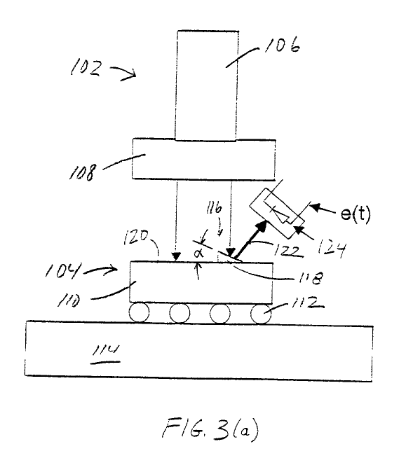

Referring now to FIG. 3(a), the PES generation device 116 is discussed in greater detail. Beam position structure 118 may operate under a diffraction mode and/or a reflective mode of operation. With a multiple set of structures 118, there will be n sets of structures, aligned orthogonally, for n degrees of translational freedom (e.g., two optical beam position structures 118 for a two-axis or degree of freedom system). In a reflective mode of operation, as mentioned earlier, beam position structures 118 include a mirror-like surface, disposed at an angle α, such that the optical error signal 122 is received by error detection device 124. In a diffractive mode, the components and operation thereof are the same, with the exception that beam position structures 118 include diffraction gratings (with appropriate dimensions for the incident optical beam wavelength). Error detection device(s) 124 is (are) then positioned so as to acquire the appropriate frequency and diffraction order signal (e.g., zero^{th}, first, etc.).

As an alternative to employing a PIN diode or array of PIN diodes, the error detection device 124 may also include a metal-semiconductor-metal (MSM) type detector or an array thereof, a charge-coupled device (CCD) type detector or an array of such, or a specialized version of a PIN diode (e.g., quadrant PIN or split diode). Furthermore, error detection device 124 may operate in either a proportional mode (wherein the optical power of the optical error signal is proportional to the degree of beam position error) or in a spatial mode (wherein the magnitude of the beam positional error is given by excitation of corresponding detector elements in an ordered spatial arrangement. The exemplary embodiment in FIG. 3 illustrates the e(t) generation and detection components for a reflective-proportional mode of operation.

In the event that other design factors (e.g., component space or cost) become increasingly important, an alternative to using “extrinsic” error detection components (i.e., beam position structure 118 and error detection device 124) is also contemplated. Rather than implementing an extrinsic (with respect to the first and second OE devices) mode of error detection, an “intrinsic” mode of error detection may also be integrated into one or both of the OE devices. For example, FIG. 3(b) is a schematic of the alignment system 100 of FIG. 1, shown without the extrinsic error detection components described above.

In this embodiment, optical data detector 110 of second OE device 104 may include circuitry therein which detects the degree of optical power actually received in the detection plane of the second OE device 104. This mode is in contrast to the extrinsic mode of error detection, where the PES is generated by the degree of optical power not reaching the detection plane (i.e., power reflected by beam position structure 118). Thus, if the magnitude of optical power actually coupled to and received by the optical data detector 110 is less than a desired value, the intrinsic mode of error detection will then generate error signal e(t) and send it directly to controller 126.

However, it should be noted that since this mode of error detection is not specific with regard to a particular directional misalignment, the error signal e(t) may be generated, for example, as a series of trial and error iterations controlled by an algorithm or algorithms. Thereby, actuator mechanism 130 adjusts the position of first OE device 102 until the desired optical power level is once again received by second OE device 104.

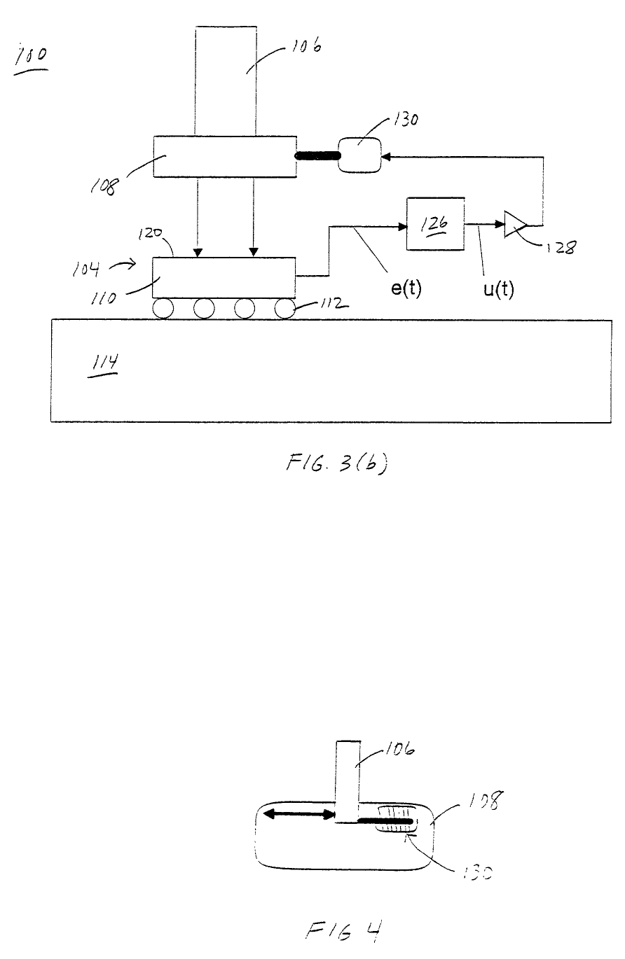

Referring now to FIG. 4, a schematic diagram of one possible embodiment of the actuator mechanism 130 is illustrated. In the illustrated embodiment, actuator mechanism 130 is disposed within housing 108 containing fiber optic cable 106. Actuator mechanism 130 may operate by such means including, but not limited to, servo means (e.g., a voice coil), magnetic means, piezoelectric means, magnetostrictive means or thermal means. Further, the actuator mechanism 130 may also be included with or without biasing means (i.e., a returning force). In the embodiment depicted in FIG. 4, the actuator mechanism 130 is schematically shown as a servo-type linear voice coil, capable of translating the end of fiber optic cable 106 along a selected axis (e.g., the x-axis). Regardless of the specific type of actuator mechanism implemented, the input system thereto may be either an analog system or a digital system. However, an analog system, for example, is a preferred embodiment over a stepper system.

FIG. 5 is a top-sectional view (in the x-y plane) illustrating a multiple degree of freedom embodiment of actuator mechanism 130. As can be seen, actuator mechanism 130 includes actuators 130x, 130y and 130z for translating fiber optic cable 106 in the x, y and z (focal) directions, respectively. In the embodiment shown, actuator 130z is directly coupled to fiber optic cable 106 through linkage 132z. In turn, actuator 130z is also directly coupled to actuator 130x through linkage 132x. Thereby, when fiber optic cable 106 is translated in the x direction by actuator 130x, actuator 130z is also physically translated as well. Furthermore, actuator 130x is directly coupled to actuator 130y through linkage 132y. Thereby, when fiber optic cable 106 is translated in the y direction by actuator 130y, both actuators 130x and 130z are also physically translated as well. It will be noted that FIG. 5 also schematically depicts actuator 130y in actuator mechanism 130 affixed to a common reference plane 134 with data detector 110 of second OE device 104.

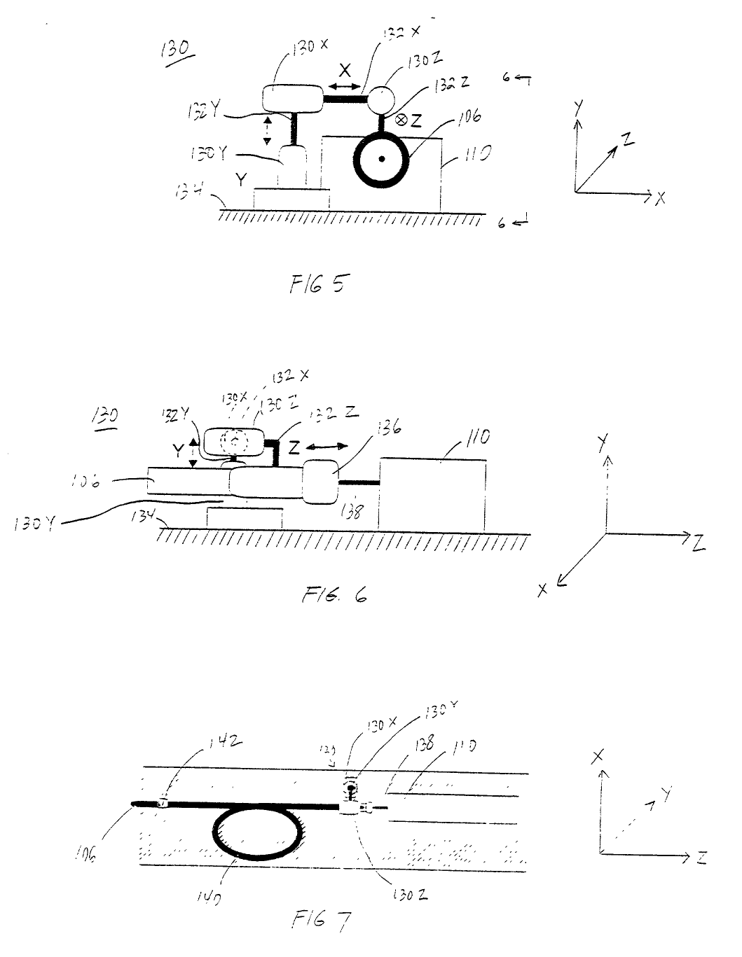

FIG. 6 is another view of the multiple degree of freedom actuator mechanism 130, (shown in the y-z plane) as viewed from the direction of arrow 6 in FIG. 5. In particular, FIG. 6 illustrates the relationship between linkage 132z, fiber optic cable 106, a capture sleeve 136, incident optical beam 138 and optical data detector 110. FIG. 7 is still another view of actuator mechanism 130, shown in the x-z plane, which illustrates one possible arrangement of fiber optic cable 106 in greater detail. As can be seen, fiber optic cable 106 may be configured to provide a strain relief loop 140 between a mechanical affixing point 142 and actuator mechanism 130. In addition, the emitting end of fiber optic cable is shown with a lens 144 to provide a focused optical beam 138.

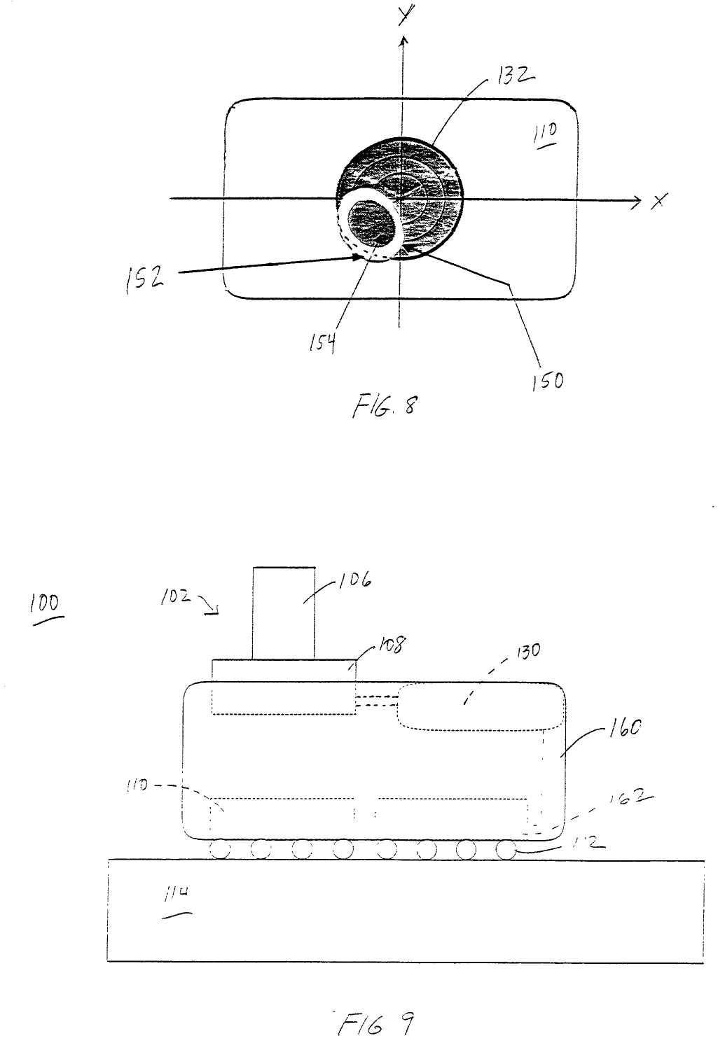

Referring now to FIG. 8, there is shown a diagram which illustrates an example of a positional error correction (in one degree of freedom) by the adjustment of an incident optical beam along the focal, or z-axis. The detector target area 132 of the optical data detector 110 is shown centered at the origin of the x and y-axes. An incident optical beam 150 has a positional error associated therewith, as shown by that portion 152 of incident optical beam 150 located outside of target area 132. Following an adjustment along the focal axis, a corrected incident beam 154 is now entirely located within the target area. It will be appreciated that in a multiple degree of freedom embodiment, additional translations along the x and y-axes could also be accomplished so as to locate corrected incident beam 154 more closely toward the origin of the x and y-axes.

Finally, FIG. 9 illustrates an alternative embodiment of alignment system 100, wherein the components thereof are included within a single, self-contained housing 160. In this embodiment, fiber optic cable 106 has its emitter end movably disposed within fixed housing or carrier piece 108. However, housing 108 is also affixed within housing 160, as are the optical data detector 110, the actuator mechanism 130 and a servo system 162 used in communication with actuator mechanism 130. The servo system 162 includes the controller 126 and driver 128, and may also include a multiplex application (not shown), containing algorithms therein, which application calculates a desired future alignment position over time.

Because alignment system 100 (specifically, actuator mechanism 130) has a wide range of possible positional states associated therewith, a sliding electrical contact means (not shown) is also contemplated so as to provide continuous electrical contact between servo system 162 and actuator mechanism 130. This may be realized, for example, through the use of a plurality of short, cantilevered-type, separable contacts, elastomer-based separable contacts, or solid pivoting/moveable type separable contacts. The routing of the requisite electrical signals within alignment system 100 may be accomplished by conventional means (e.g., flex circuits, PWBs, etc.).

Regardless of the embodiments depicted, it will be seen that alignment system 100 provides a self-contained, closed loop system wherein an optical signal input (e.g., from a fiber optic cable) is somewhat roughly aligned and affixed with a corresponding optical data receiving device. System 100 then performs the initial and real-time, fine alignment translations between the input device and the receiving device, while accounting for temperature and stress-strain excursions during sustained operation of the optical devices in changing environmental conditions.

A further advantage, as opposed to existing “align and affix” systems, is that the present invention embodiments do not make use of traditional methods for affixing optically coupled OE devices with respect to one another. For example, the use of an organic adhesive or solder outside the OE devices themselves may affect the index of refraction of the optical beam, if part of the material resides directly within the propagation path. In addition, the adhesives may degrade over time which could result in microcracks within the adhesive material, thereby possibly resulting in optical power loss.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A real-time, optoelectronic (OE) alignment system, comprising:
a first OE device;
a second OE device optically coupled to said first OE device;
a capturing means for maintaining said second OE device in a fixed position, said capturing means further retaining said first OE device in optical engagement with said second OE device, and said first OE device further having a plurality of degrees of positional freedom associated therewith;
an error detection means for generating a positional error signal, whenever either of said first and second OE devices has deviated from a desired optical alignment with respect to the other; and
an actuation means, responsive to said error detection means, said actuation means for automatically adjusting the position of said first OE device so as to bring said first OE device in said desired optical alignment with said second OE device.

2. The OE alignment system of claim 1, wherein:
said second OE device is affixed to a reference plane;
said first OE device is movably disposed within a housing; and
said housing is affixed with respect to said second OE device.

3. The OE alignment system of claim 2, wherein said actuation means is disposed within said housing.

4. The OE alignment system of claim 2, wherein said first OE device further comprises one of:
an active device emitter; and
an emitting end of a fiber optic cable.

5. The OE alignment system of claim 1, wherein said error detection means further comprises:
a beam position structure, affixed to one of said first and second OE devices, said beam position structure located so as to reflect a portion of an incident optical beam originating from the other of said first and second OE devices; and
an optical sensing device, said optical sensing device located so as to detect said reflected portion of said incident optical beam;
wherein said optical sensing device generates said positional error signal, said positional error signal having a magnitude proportional to the degree of deviation from said desired optical alignment.

6. The OE alignment system of claim 5, further comprising:
a controller, said controller converting said positional error signal to correction signal, said correction signal being inputted to said actuation means.

7. The OE alignment system of claim 6, further comprising:
a driver, said driver having said correction signal as an input thereto and an output for providing a controlled current to said actuation means.

8. The OE alignment system of claim 3, wherein said actuation means further comprises:
a plurality of actuator mechanisms, each of said plurality of actuator mechanisms capable of imparting a translating motion upon said first OE device.

9. The OE alignment system of claim 8, further comprising:
a first actuator mechanism having a first linkage directly coupled to said first OE device;
a second actuator mechanism having a second linkage directly coupled to said first actuator mechanism; and
a third actuator mechanism having a third linkage directly coupled to said second actuator mechanism, said third actuator mechanism being affixed within said housing.

10. The OE alignment system of claim 9, wherein:
said first actuator is capable of translating said first OE device along a first axis;
said second actuator is capable of translating said first OE device along a second axis which is orthogonal to said first axis; and
said third actuator is capable of translating said first OE device along a third axis which is orthogonal to both said first and second axes.

11. The OE alignment system of claim 5, wherein said error detection means compares the magnitude of optical power received by said second OE device to a desired optical power level.

12. The OE alignment system of claim 11, wherein said error detection means generates said positional error signal whenever said magnitude of optical power received by said second OE device is less than said desired optical power level.

13. A method for automatically adjusting the optical alignment of devices within an active, optoelectronic (OE) system, the method comprising:
optically coupling a first OE device to a second OE device in a desired optical alignment;
maintaining said second OE device in a fixed position while retaining said first OE device in moveable optical engagement with said second OE device, said first OE device further having a plurality of degrees of positional freedom associated therewith;
generating a positional error signal whenever either of said first and second OE devices has deviated from said desired optical alignment with respect to the other; and
responsive to said error detection means, automatically adjusting the position of said first OE device so as to bring said first OE device in said desired optical alignment with said second OE device.

14. The method of claim 13, wherein:
said second OE device is affixed to a reference plane;
said first OE device is movably disposed within a housing; and
said housing is affixed with respect to said second OE device.

15. The method of claim 14, wherein the position of said first OE device is adjusted within said housing.

16. The method of claim 14, wherein said first OE device further comprises one of:
an active device emitter; and
an emitting end of a fiber optic cable.

17. The method of claim 13, further comprising:
affixing a beam position structure to one of said first and second OE devices, said beam position structure located so as to reflect a portion of an incident optical beam originating from the other of said first and second OE devices; and
locating an optical sensing device so as to detect said reflected portion of said incident optical beam;
wherein said optical sensing device generates said positional error signal, said positional error signal having a magnitude proportional to the degree of deviation from said desired optical alignment.

18. The method of claim 17, further comprising:
converting said positional error signal to a correction signal, said correction signal being used to adjust the position of said first OE device.

19. The method of claim 18, further comprising:
generating a controlled current from a driver, said driver having said correction signal as an input thereto and an output coupled to an actuation means.

20. The method of claim 19, wherein said actuator means further comprises:
a first actuator mechanism having a first linkage directly coupled to said first OE device;
a second actuator mechanism having a second linkage directly coupled to said first actuator mechanism; and
a third actuator mechanism having a third linkage directly coupled to said second actuator mechanism, said third actuator mechanism being affixed within said housing.
